(19) United States
(12) Patent Application Publication
(10) Pub. No.: US 2006/0067505 A1
(43) Pub. Date: Mar. 30, 2006

(54) Methods and apparatus to control distribution of call information

(76) Inventor: Wayne Heinmiller, Elgin, IL (US)

Correspondence Address: GROSSMAN & FLIGHT LLC, Suite 4220, 20 North Wacker Drive, Chicago, IL, 60606-6357, US

(21) Appl. No.: 10/950,208

(22) Filed: Sep. 24, 2004

(51) Int. Cl. H04M 7/00

(52) U.S. Cl. 379/229; 379/221.08

(57) ABSTRACT

Methods and apparatus for controlling the distribution of call information via telephone networks are disclosed. A disclosed method receives call information from a first switching point at an intermediate control point, retrieves from a database at the intermediate control point profile information associated with a second switching point, and modifies the call information based on the profile information.

### FIELD OF THE DISCLOSURE

The present disclosure relates generally to telephone networks and, more specifically, to methods and apparatus to control distribution of call information.

### BACKGROUND

Telephone communication networks typically employ a common channel signaling scheme that functions as a network-to-network interface to enable communications between different carrier operated telephone networks or switches. In this manner, the common channel signaling scheme enables efficient interoperation the telephone networks or switches owned and operated by various regional telephone companies, long distance service providers, etc.

Signaling system seven (SS7) is one particularly well-known common channel signaling architecture, scheme or protocol that may be used to enable carrier-to-carrier communications. In some telephone network applications, SS7 is used to control or configure communication trunks that convey voice calls between carriers using the integrated digital services network user part (ISUP) of the SS7 protocol. While common channel signaling schemes such as SS7 have been successfully deployed for use with carrier owned and operated public telephone switching networks, the use of a common channel signaling scheme such as SS7 with non-carrier networks or switches has presented some difficulties. For example, it may not be desirable or permissible to convey certain call signaling information to privately owned and operated telephone equipment such as, for example, private telephone switching networks (e.g., private branch exchange systems) used by corporations, building owners, etc. More generally, providing complete transparency of call signaling information between non-carrier or private networks or switches and carrier operated public networks or switches may be restricted or prohibited as a result of one or more legal or regulatory issues.

In one known system that conveys SS7 signaling information between carrier and non-carrier operated telephone switches, privacy indicators sent with call configuration or setup data are used to identify certain calling party signaling data as private and, thus, not to be conveyed to non-carrier private switching equipment. More specifically, in this known system, a first signal switching point (SSP) associated with a calling party marks certain signaling data associated with the calling party's call (e.g., the caller's phone number) as private. The marked signaling data is then conveyed via one or more signal transfer points (STPs) to a signal control point (SCP) that examines the signaling data and privacy markers to generate modified signaling data to be sent to a second SSP associated with a non-carrier operated network. The SCP hides data marked as private (as determined from the privacy indicators sent with the signaling data) by inserting nonsense data in the data fields associated with the private data and returns the modified signaling data to the first SSP. The first SSP then conveys the modified signaling data to the second SSP to set up the call without exposing the caller's phone number to the non-carrier switching network associated with the second SSP.

While the known system described above enables one type of signaling data to be hidden from non-carrier networks, the capabilities of that known system are somewhat limited. For instance, the above-described known system does not enable signaling parameters to be restricted, modified, or added (e.g., inserted) based on a relationship between an entity that owns or operates a first SSP and another entity owning or operating a second SSP.

### BRIEF DESCRIPTION OF THE DRAWINGS

FIG. 1 depicts an example telephone network within which the example methods and apparatus described herein may be implemented.

FIG. 2 depicts an example query-based call information modification method that may be implemented within the example telephone network of FIG. 1 for use with outgoing calls.

FIG. 3 depicts another example query-based call information modification method that may be implemented within the example telephone network of FIG. 1 for use with incoming calls.

FIG. 4 depicts an example non-query based call information modification method that may be implemented within the example telephone network of FIG. 1.

FIG. 5 is an example processor system that may be used to implement one or more of the structures shown in FIG. 1.

FIG. 6 is an example system that may be used to implement the example methods described herein.

### DETAILED DESCRIPTION

In general, the example methods and apparatus described herein enable call information to be conveyed between carrier operated public telephone networks or switches and non-carrier privately operated telephone networks or switches in accordance with legal requirements, government regulatory requirements, contractual requirements, and/or business requirements. More specifically, with the example methods and apparatus described herein, call information associated with a call to be established between an SSP associated with a carrier operated telephone network and an SSP associated with a non-carrier operated telephone network is processed at an intermediate control point. The intermediate control point, which may be, for example, an SCP or an adjunct processing system, is configured to retrieve and apply switching point profile information, which may be representative of a relationship between the non-carrier operated telephone network and the carrier operated telephone network (e.g., the telephone network as a whole, one or more SSPs coupled to the telephone network, one or more SCPs coupled to the telephone network, etc.) The intermediate control point may then modify the call information (e.g., delete data, change data, and/or add data) based on the switching point profile information.

In some examples, the switching point profile information reflects a legal or regulatory and/or a business or contractual relationship between the non-carrier network or switch and the carrier operated network or switch. Call information modified at the intermediate control point is then conveyed to the SSP associated with the call destination without exposing, for example, data required to remain private and/or other data that is not desirably or permissibly conveyed between the carrier and non-carrier networks or switches.

Although the following discloses example systems, including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the following describes example systems, persons of ordinary skill in the art will readily appreciate that the examples are not the only way to implement such systems.

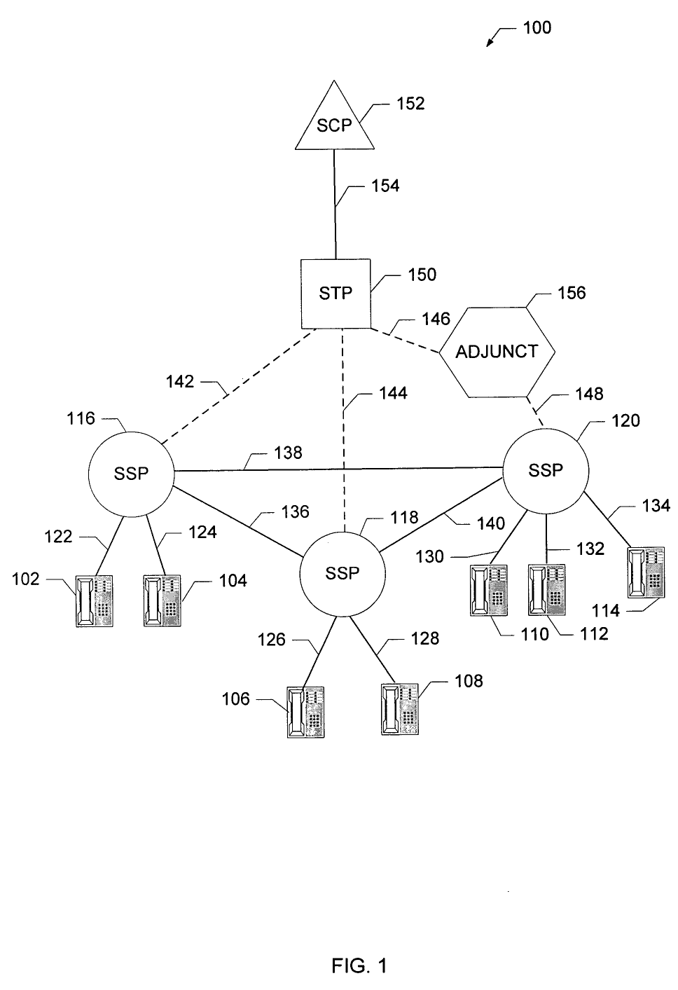

Turning to FIG. 1, an example telephone network 100 within which the example methods and apparatus described herein may be implemented is shown. The example telephone network 100 includes a plurality of telephone stations 102, 104, 106, 108, 110, 112 and 114 that are coupled to SSPs 116, 118 and 120 via respective communication links 122, 124, 126, 128, 130, 132 and 134. The SSPs 116, 118 and 120 are communicatively coupled via communication trunks 136, 138 and 140 and are further communicatively coupled via common channel signaling links 142, 144, 146 and 148 to a signal transfer point 150. The signal transfer point 150 is further communicatively coupled to an SCP 152 via a communication link 154. Of course, additional STPs 150, SCPs 152 and SSPs 116, 118, and 120 may be present.

In general, the example telephone network 100 is configured to provide advanced intelligent network (AIN) functionality. For example, the example telephone network 100 of FIG. 1 enables one or more of the telephone stations 102, 104, 106, 108, 110, 112, and 114 to be used to implement AIN-type functionality such as, for example, calls involving call forwarding, call screening, enhanced call billing, etc. The SSPs 116, 118 and 120 are configured to recognize AIN-type calls and to work cooperatively with the SCP 152 to process and route such calls. More particularly, the SSPs 116, 118 and 120 are digital programmable switches that are configured to send queries to the SCP 152 and to receive data and/or commands from the SCP 152 to enable the SSPs 116, 118, and 120 to process the AIN-type calls. Although one type of telephone architecture is depicted in the example telephone network 100 of FIG. 1, the example methods described herein may be applied to other telephone system architectures, arrangements, etc.

As noted above, the SSPs 116, 118 and 120 are digital programmable switches that may be configured to recognize AIN-type calls, launch queries to the SCP 152, receive commands and data from the SCP 152 to process and route AIN-type calls, etc. One or more of the SSPs 116, 118 and 120 may be carrier operated switches (i.e., operated by a recognized public telephone service provider), which are commonly referred to as central offices, and/or one or more of the SSP 116, 118 and 120 may be non-carrier operated switches such as, for example, a private branch exchange (PBX) system or the like. For purposes of describing the example methods and apparatus herein, the SSP 116 is described as a carrier operated switch or network and the SSPs 118 and 120 are described as non-carrier operated switches or networks. Of course, it should be recognized that other examples including more or fewer SSPs and/or having more or fewer carrier operated and/or non-carrier operated switches or networks than those shown in the example network 100 of FIG. 1 could be used instead.

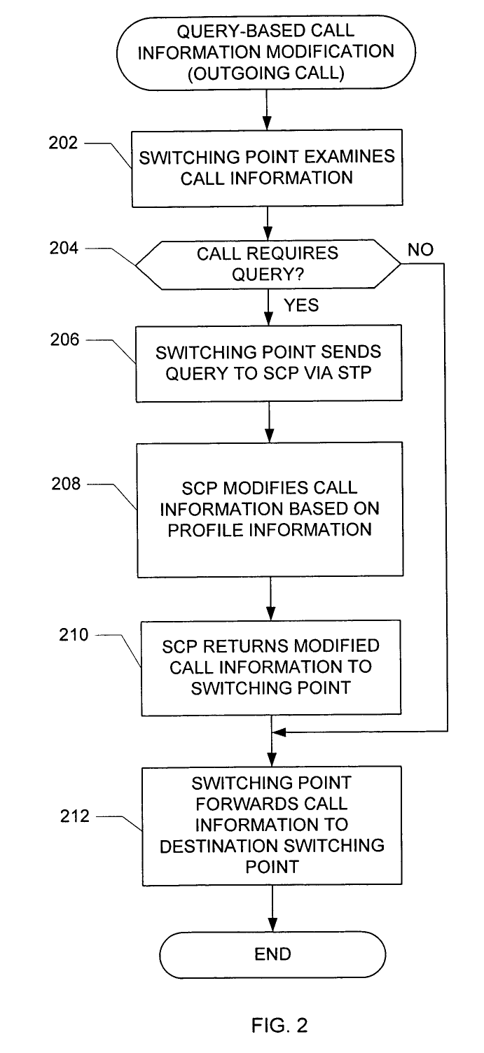

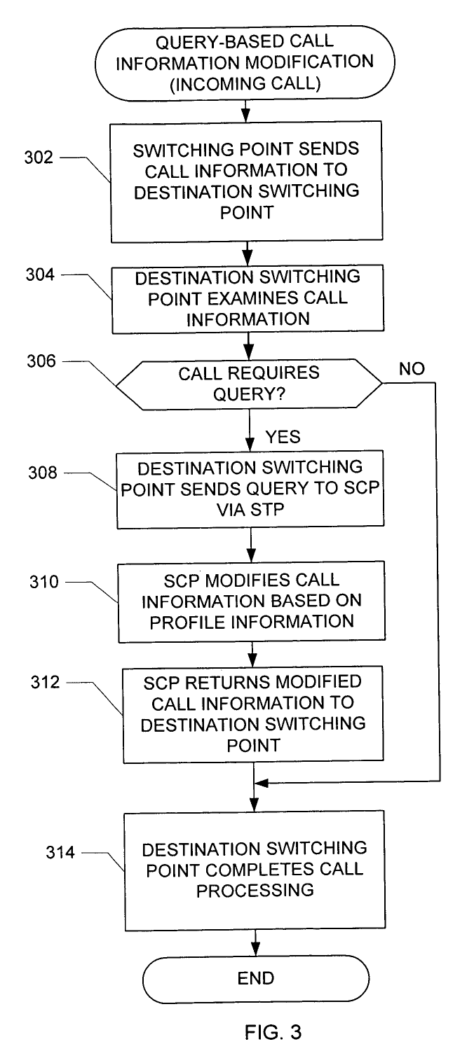

The signal transfer point 150 functions as a packet switch using well-known methods to route call signaling information, data, commands, etc. among the SSPs 116, 118 and 120 and the SCP 152. The SCP 152 includes a database containing translation and routing data. The SCP 152 may use a number of well-known methods to access its database to determine the manner in which calls are to be routed, billed, etc. However, as described in greater detail in connection with FIGS. 2 and 3 and in contrast to known SCP apparatus, the SCP 152 may be configured to alter or modify call information (e.g., SS7 compliant signaling data) based on a profile of a non-carrier operated SSP (e.g., a destination SSP associated with a call placed to a non-carrier operated SSP). The profile of the non-carrier operated SSP may reflect a relationship that the non-carrier SSP has with respect to the telephone network 100 and/or one or more SCPs, SSPs, and/or other entities or equipment associated with the network 100. For instance, the SCP 152 may add data, delete data and/or change data associated with a particular call based on a business or contractual relationship that the non-carrier operated switching point has with respect to the telephone network 100 as a whole and/or one or more other entities owning equipment coupled to the network 100. In the case where the destination switching point is operated by a private entity, the SCP 152 may delete or otherwise hide a caller's name and phone number, carrier identification information, local number portability (LNP) information, etc.

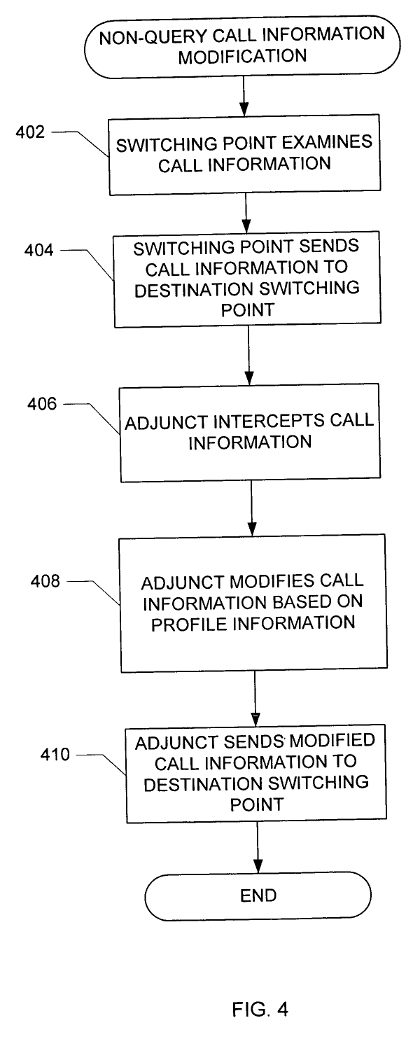

In the example telephone network 100 of FIG. 1, an adjunct processing unit or system 156 is communicatively interposed between the SSP 120 and the signal transfer point 150. An adjunct processing unit or system such as the system 156 functions as a decentralized SCP and, thus, typically services a specific geographic area and a relatively limited number of SSPs or switches. Thus, additional adjunct processing systems could be communicatively interposed between the SSPs 116 and 118 and the signal transfer point 150. Alternatively, adjunct processing systems may not be used within the network 100. In contrast to known adjunct processing systems and as described in greater detail below in connection with FIG. 4, the adjunct processing system 156 may be configured to add, delete, change or otherwise modify or alter intercepted call signaling information based on a business, contractual and/or a legal or regulatory relationship between a non-carrier operated SSP and the telephone network 100 and/or one or more other systems coupled to the network 100.

The example methods described below in connection with FIGS. 2, 3 and 4 can be implemented as machine readable and/or executable instructions stored or otherwise embodied on a computer accessible or readable medium such as, for example, a solid state memory (e.g., DRAM, SRAM, DD-RAM, flash memory, etc.), an optical storage medium (e.g., a DVD, a CD, etc.), a magnetic storage medium (e.g., a hard disk drive, a floppy disk, etc.), or any other medium suitable for storing machine readable and/or executable instructions. Further, although the blocks depicted in the example methods of FIGS. 2, 3 and 4 represent a particular order of operations, the order of some or all of the blocks could be changed to accomplish the same or similar results.

FIG. 2 depicts an example query-based call information modification method that may be implemented within the example telephone network 100 of FIG. 1 for use with outgoing calls (e.g., a call originating at a carrier operated switch or network and having a destination at a non-carrier operated switch or network). For purposes of the following discussion, the example method of FIG. 2 is described in connection with a call originating at the telephone station 102 and requesting a connection to the telephone station 106. However, the example method of FIG. 2 can be more generally applied to implement any query-based call between any switching points of a telephone network.

Initially, the SSP 116 examines call information associated with the call placed via the telephone station 102 and its associated link 122 (block 202). Such an examination of the call information may include determining whether execution of the call requires AIN-type functionality (e.g., call forwarding), the nature of the destination switching point (e.g., whether the destination switching point is associated with a private entity or any other non-carrier entity), etc.

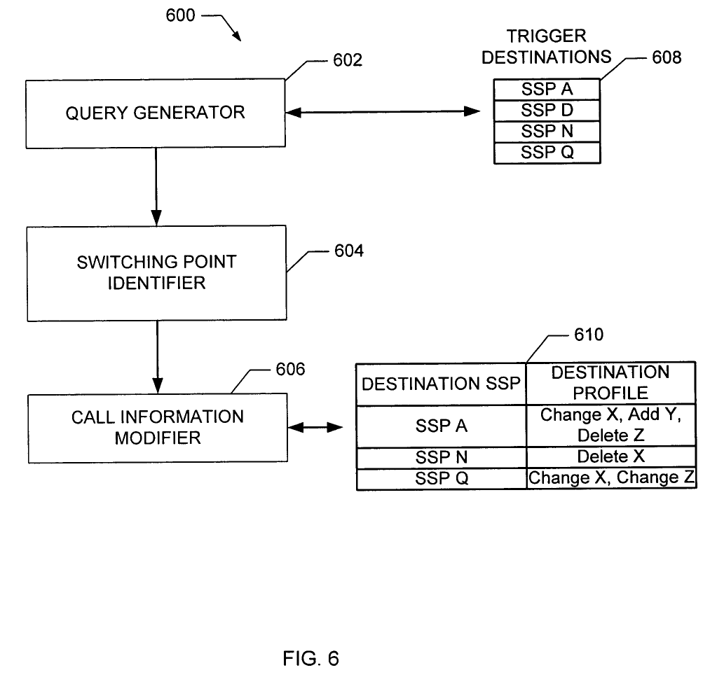

After examining the call information (block 202), the SSP 116 determines if the call requires a query (block 204). In general, calls requiring AIN-type functionality (e.g., further processing at the SCP 152) require a query to be sent to, for example, an SCP. In the example of FIG. 2, the SSP 116 uses the results of the call information examination (block 202) to identify calls directed to destination SSPs for which call information is to be modified based on the profiles of the destination SSPs. As discussed in greater detail in connection with FIG. 6, the SSP 116 may use a database containing a list or other suitable data structure including profile information associated with those destination SSPs for which call information is to be modified by the SCP 152 before completing the call.

If the SSP determines at block 204 that a query is required, the SSP 116 sends a query (which includes the call signaling information) via the link 142, the signal transfer point 150 and the link 154 to the SCP 152 (block 206). The SCP 152 then examines the call information and modifies the call information based on the profile of the destination or non-carrier operated SSP (block 208). For example, if the destination of the call placed by the telephone station 102 via the SSP 116 is the SSP 118 which, in this example, is a non-carrier operated or privately operated switch, the SCP 152 may alter or modify the call information to eliminate, for example, information uniquely associated with the caller, the location of the caller, or that could be used to identify attributes of the caller's service. Similarly, the SCP 152 may alter or modify the call information to modify or eliminate carrier-related information that would be inappropriate or unnecessary for the non-carrier's operations. In this example, the SCP 152 may store or otherwise have access to (e.g., may selectively retrieve information from) a database including a list or other record or data structure containing profile information pertaining to SSPs (e.g., non-carrier operated) that require altered or modified call information. The SSPs in the database may require altered or modified call information based on, for example, on a business or contractual relationship to the network 100 and/or one or more other entities coupled to the network 100, governmental requirements, regulatory requirements, etc. In any event, such a list or record may then be used by the SCP 152 as it receives call information associated with calls placed via, for example, the telephone stations 102 and 104 to quickly determine whether those calls require altered or modified call information. As described in greater detail below, altered or modified call information or signaling may be required in cases where it is not desirable or permissible to convey certain call information available at the carrier operated SSP 116 to another SSP such as, for example, a non-carrier operated or privately operated switching point (e.g., the SSPs 118 and 120).

In some cases, the application of profile information results in the deletion or hiding of certain call information. For example, in the case where the destination switch is the privately operated SSP 118, caller identifying information (e.g., a caller's name, phone number, billing number, type of service, etc.), carrier identification information, and the like may be deleted or hidden (e.g., overwritten with nonsense data) to prevent the privately operated SSP 118 from receiving and having access to this information. Alternatively or additionally, the application of the profile information at the SCP 152 may result in the addition of data to the signaling information for the call and/or the changing of data making up the signaling information.

The SCP 152 may store or otherwise have access to a plurality of profiles, each of which may correspond to a different destination SSP or group of SSPs. Thus, the manner in which call information is conveyed from a given SSP originating a call to different destination SSPs can vary based on the relationship each of the destination SSPs has with respect to the telephone network 100 as a whole, an originating SSP, an SCP, and/or any other entity's equipment coupled to the network 100.

After the SCP 152 has altered or modified the call information (block 208), the SCP 152 returns the modified call information to the SSP 116 (block 210). The SSP 116 then forwards the modified call information to the destination SSP (i.e., the SSP 118) via the link 142, the signal transfer point 150 and the link 144 to configure or setup the trunk 136 to execute the call originating at the telephone station 102 (block 212).

In some cases, altered signaling may not be required (block 204). For example, if the telephone station 102 initiates a call to a telephone station coupled to another carrier operated SSP, it may be permissible and/or desirable to send all call information to that SSP without modifying or otherwise altering the call information. In that case, in the example of FIG. 2, the SSP 116 sends unmodified call information to the destination SSP.

FIG. 3 depicts another example query-based call information modification method that may be implemented within the example telephone network 100 of FIG. 1 for use with incoming calls. For purposes of illustrating the example method of FIG. 3, the incoming call is originated by the telephone station 106 coupled to the non-carrier or privately operated SSP 118. In addition, in this example, the destination of the call is the telephone station 102 coupled to the carrier operated SSP 116.

Initially, the SSP 118 sends call information via the link 144, the signal transfer point 150 and the link 142 to the SSP 116 (block 302). The SSP 116 then examines the call information (block 304) and determines if the call requires a query (block 306). The operations of blocks 304 and 306 may be implemented as described above in connection with blocks 202 and 204 of FIG. 2.

If a query is required (block 306), the destination carrier operated SSP 116 then sends a query to the SCP 152 via the link 142, the signal transfer point 150 and the link 154 (block 308). The SCP 152 then modifies the call information based on profile information associated with the originating non-carrier operated SSP 118 in a manner similar to that described in connection with block 208 of FIG. 2. For example, carrier information may be added to the call information in cases where the non-carrier operated SSP 118 is not able to provide such information. The SCP 152 then returns the modified call information to the destination SSP 116 (block 312), which then completes the call processing using the modified call information (block 314).

FIG. 4 depicts an example non-query based call information modification method that may be implemented within the example telephone network 100 of FIG. 1. In the case of an outgoing call initiated by, for example, the telephone station 102, the SSP 116 examines the call information (block 402) and sends the call information to the signal transfer point 150 via the link 142 (block 404). In this example, the call destination is the SSP 120 and the telephone station 110 and the SSP 120 is a non-carrier operated switch that is coupled to the adjunct processing system 156 via the link 148. In contrast to the example methods of FIGS. 2 and 3, the signal transfer point 150 does not convey the call information to the SCP 152. Instead, the adjunct processing system 156 intercepts or otherwise receives the call information directly from the signal transfer point 150 via the link 146 (block 406) prior to the call information reaching the destination SSP 120. The adjunct processing system 156 then modifies or alters the call information based on profile information associated with the switching signal point 120 in a manner similar or identical to that described above in connection with block 208 (block 408). The adjunct processing system 156 then conveys the call information (including any modifications or alterations) to the destination SSP 120 (block 410).

The example method depicted in FIG. 4 is described above in connection with an outgoing call (e.g., a call originating at a carrier operated SSP and having a destination at a non-carrier SSP). However, the example method of FIG. 4 can also be applied in the case of an incoming call (e.g., a call originating at a non-carrier SSP and having a destination at a carrier operated SSP). In an example case of an incoming call, the non-carrier operated SSP 120 examines call information associated with a call place via the telephone station 110 (block 402) and sends the call information to the carrier operated SSP 116 via the link 148 (block 404). However, the adjunct processing system 156 receives or intercepts the call information (block 406) and then modifies the call information based on profile information associated with the non-carrier switching point 120 and the network 100 (block 408). The adjunct processing system 156 then sends the call information (including any modifications or alterations) to the SSP 116 (block 410).

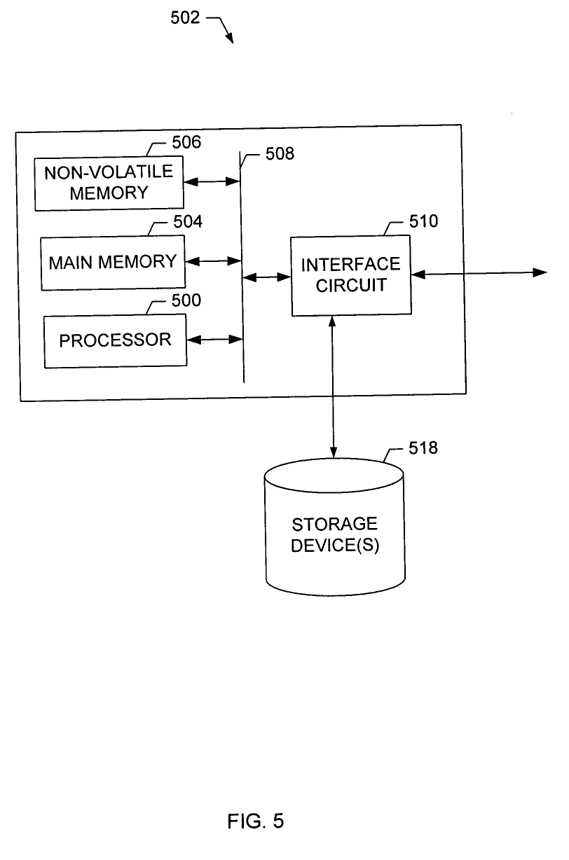

An example processor system 502 that may be used to implement, for example, the SCP 152 and/or the adjunct processing system 156, is shown in FIG. 5. The example processor-based system 502 may be, for example, a server, a personal computer, or any other type of computing device.

The processor 500 may, for example, be implemented using one or more Intel® microprocessors from the Pentium® family, the Itanium® family or the XScale® family. Of course, other processors from other families are also appropriate. The processor 500 is in communication with a main memory including a volatile memory 504 and a non-volatile memory 506 via a bus 508. The volatile memory 504 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 506 may be implemented by flash memory and/or any other desired type of memory device. Access to the memory 504 is typically controlled by a memory controller (not shown) in a conventional manner.

The system 502 also includes an interface circuit 510. The interface circuit 510 may be implemented by any type of well-known interface standard to, for example, enable the system 502 to communicate via one or more of the links 142, 144, 146, 148 and 154.

The system 502 also includes one or more mass storage devices 518 for storing software and/or data. Examples of such mass storage devices include floppy disk drives, hard drive disks, compact disk drives and digital versatile disk (DVD) drives.

Turning to FIG. 6, an example system 600 that may be used to implement the example methods disclosed herein is shown. The example system 600 includes a query generator 602, a switching point identifier 604, and a call information modifier 606 that are communicatively coupled as shown. As depicted in FIG. 6, the query generator 602 has access to trigger destination information 608 and the call information modifier 606 has access to SSP profile information 610.

In one example, the query generator 602 is integrated within a carrier operated SSP such as, for example, the SSP 116 (FIG. 1), the switching point identifier 604 is integrated within an SCP such as, for example, the SCP 152 (FIG. 1), and the call information modifier 606 is integrated within the SCP (e.g., the SCP 152). In general, the query generator 602 is configured to receive call information from one or more telephone stations (e.g., the telephone stations 102 and 104 of FIG. 1) and to compare the call information to the trigger destination information 608 to determine if a query should be generated in response to the call information. In the example of FIG. 6, the trigger destination information 608 includes a table, list, or any other suitable data structure containing the identities of SSPs for which queries must be generated. The SSPs identified in the trigger destination information 608 may require AIN-type functionality or processing such as, for example, the call information modification techniques described in connection with FIGS. 2, 3 and 4. If the query generator 602 determines that received call information (e.g., a destination SSP indicated within the received call information) matches one of the SSPs in the trigger destination information 608, the query generator 602 generates a query and conveys the query to the switching point identifier 604, which may be integrated within an SCP (e.g., the SCP 152) as noted above.

The switching point identifier 604 is configured to examine the call information in the query received from the query generator 602 and to determine the destination switching point associated with the call. The call information modifier 606 receives the destination switching point information from the switching point identifier 604 and accesses the SSP profile information 610 to determine the manner in which call information needs to be modified. In general, the SSP profile information 610 may be embodied as a table, linked list, or any other suitable data structure that enables destination switching points to be associated with instructions or other information pertaining to the manner in which data associated with the call information needs to be changed, deleted, added in accordance with, for example, a relationship between the destination switching point and the telephone network or the switching point originating the call. As discussed above in connection with FIGS. 2, 3 and 4, the relationship may be a business relationship, a contractual relationship, a regulatory relationship, a governmental relationship, or any other relationship that affects the manner in which call information is to be distributed.

The profile information accessed or retrieved by the call information modifier 606 is then used by the call information modifier 606 to modify the call information. The modified call information may then be returned to the switching point that will complete the call.

As can be appreciated from the foregoing description, the example methods and apparatus described herein enable a carrier operated SSP to convey an outgoing call or to receive an incoming call from a non-carrier or privately operated SSP in compliance with certain requirements or restrictions relating to call signaling information. In contrast to known manners of conveying call information in telephone networks, the example methods and apparatus described herein enable call information (including non-private call information) associated with a particular telephone station and/or carrier operated switching point to be changed, modified, or otherwise altered in different manners (without reference to privacy restriction indicators as is required in at least one known system) for different non-carrier operated SSPs and associated telephone stations.

Further, the example methods described, in FIGS. 2, 3, and 4 can be implemented without having to modify the SSP hardware/software, which is an extremely difficult task in the case of non-carrier operated SSPs. In some of the above-described examples, the carrier operated SCP within an AIN-type network can be modified to include appropriate software and/or hardware. Alternatively or additionally, one or more adjunct processing systems can be modified to include appropriate hardware and/or software to implement some of the above-described examples.

Although certain methods, apparatus, and articles of manufacture have been described herein, the scope of coverage of this patent is not limited thereto. To the contrary, this patent covers all methods, apparatus and articles of manufacture fairly falling within the scope of the appended claims either literally or under the doctrine of equivalents.

What is claimed is:

1. A method of controlling the distribution of call information via a telephone network, comprising:
receiving call information from a first switching point at an intermediate control point;
retrieving from a database at the intermediate control point profile information associated with a second switching point; and
modifying the call information based on the profile information.

2. A method as defined in claim 1, wherein retrieving the profile information comprises retrieving information associated with a relationship of the second switching point to the telephone network or the first switching point.

3. A method as defined in claim 2, wherein the relationship of the second switching point to the telephone network or the first switching point is a business relationship, a contractual relationship, a legal relationship, or a regulatory relationship.

4. A method as defined in claim 1, wherein retrieving the profile information comprises retrieving information defining information to be conveyed to the second switching point in accordance with a business relationship of the second switching point to the telephone network or the first switching point.

5. A method as defined in claim 1, wherein modifying the call information comprises modifying non-private information based on the profile information.

6. A method as defined in claim 1, further comprising conveying the modified call information to the second switching point via the first switching point or an adjunct processing system.

7. A method as defined in claim 1, wherein modifying the call information comprises changing data, adding data or deleting data.

8. A method as defined in claim 7, wherein changing the data, adding the data or deleting the data comprises modifying information associated with a common channel signaling protocol.

9. A method as defined in claim 1, wherein receiving the call information at the intermediate control point comprises receiving the call information at a signal control point or an adjunct processing system.

10. A method as defined in claim 1, wherein the first switching point is associated with a public network and the second switching point is associated with a private network.

11. A method as defined in claim 1, wherein the first switching point is associated with a carrier operated network and the second switching point is associated with a non-carrier operated network.

12. A method as defined in claim 1, wherein the first switching point is associated with an outgoing call or an incoming call.

13. A method as defined in claim 1, wherein the first switching point is associated with a call originating switching point, and wherein the second switching point is associated with a call destination switching point.

14. A control point for use in a telephone network, the control point comprising:
a memory; and
a processor coupled to the memory and configured to:
receive call information from a first switching point at an intermediate control point;
retrieve from a database at the intermediate control point information profile information associated with a second switching point; and
modify the call information based on the profile information.

15. A control point as defined in claim 14, wherein the processor is configured to retrieve the profile information by retrieving information associated with a relationship of the second switching point to the telephone network or the first switching point.

16. A control point as defined in claim 15, wherein the relationship of the second switching point to the telephone network or the first switching point is a business relationship, a contractual relationship, a legal relationship, or a regulatory relationship.

17. A control point as defined in claim 14, wherein the processor is configured to retrieve the profile information by retrieving information defining information to be conveyed to the second switching point in accordance with a business relationship of the second switching point to the telephone network or the first switching point.

18. A control point defined in claim 14, wherein the processor is configured to modify the call information by modifying non-private information based on the profile information.

19. A control point as defined in claim 14, wherein the processor is configured to convey the modified call information to the second switching point via the first switching point or an adjunct processing system.

20. A control point as defined in claim 14, wherein the processor is configured to modify the call information by changing data, adding data or deleting data.

21. A control point as defined in claim 20, wherein the processor is configured to change the data, add the data or delete the data by modifying information associated with a common channel signaling protocol.

22. A control point as defined in claim 14, wherein the processor is configured to receive the call information at the intermediate control point by receiving the call information at a signal control point or an adjunct processing system.

23. A control point as defined in claim 14, wherein the first switching point is associated with a public network and the second switching point is associated with a private network.

24. A control point as defined in claim 14, wherein the first switching point is associated with a carrier operated network and the second switching point is associated with a non-carrier operated network.

25. A control point as defined in claim 14, wherein the first switching point is associated with an outgoing call or an incoming call.

26. A control point as defined in claim 14, wherein the first switching point is associated with a call originating switching point, and wherein the second switching point is associated with a call destination switching point.

27. A machine accessible medium having instructions stored thereon that, when executed, cause a machine to:
receive call information from a first switching point at-an intermediate control point;
retrieve from a database at the intermediate control point profile information associated with a second switching point; and
modify the call information based on the profile information.

28. A machine accessible medium as defined in claim 27 having instructions thereon that, when executed, cause the machine to retrieve the profile information by retrieving information associated with a relationship of the second switching point to the telephone network or the first switching point.

29. A machine accessible medium as defined in claim 28, wherein the relationship of the second switching point to the telephone network or the first switching point is a business relationship, a contractual relationship, a legal relationship, or a regulatory relationship.

30. A machine accessible medium as defined in claim 27 having instructions stored thereon that, when executed, cause the machine to retrieve the profile information by retrieving information defining information to be conveyed to the second switching point in accordance with a business relationship of the second switching point to the telephone network or the first switching point.

31. A machine accessible medium as defined in claim 27 having instructions stored thereon that, when executed, cause the machine to modify the call information by modifying non-private information based on the profile information.

32. A machine accessible medium as defined in claim 27 having instructions stored thereon that, when executed, cause the machine to convey the modified call information to the second switching point via the first switching point or an adjunct processing system.

33. A machine accessible medium as defined in claim 27 having instructions stored thereon that, when executed, cause the machine to modify the call information by changing data, adding data or deleting data.

34. A machine accessible medium as defined in claim 33 having instructions stored thereon that, when executed, cause the machine to change the data, add the data or delete the data by modifying information associated with a common channel signaling protocol.

35. A machine accessible medium as defined in claim 27 having instructions stored thereon that, when executed, cause the machine to receive the call information at the intermediate control point by receiving the call information at a signal control point or an adjunct processing system.

36. A machine accessible medium as defined in claim 27, wherein the first switching point is associated with a public network and the second switching point is associated with a private network.

37. A machine accessible medium as defined in claim 27, wherein the first switching point is associated with a carrier operated network and the second switching point is associated with a non-carrier operated network.

38. A machine accessible medium defined in claim 27, wherein the first switching point is associated with an outgoing call or an incoming call.

39. A machine accessible medium as defined in claim 27, wherein the first switching point is associated with a call originating switching point, and wherein the second switching point is associated with a call destination switching point.

40. A telephone network control point, comprising:
a database containing switching point profile information; and
a processor coupled to the database and configured to receive call information from a first switching point, to select switching point profile information representative of a second switching point from the database, and to modify the call information based on the selected switching point profile information.

41. A telephone network control point as defined in claim 40, wherein the second switching point is a privately operated switching point.

42. A telephone network control point as defined in claim 40, wherein the processor is configured to modify the call information by adding data to the call information.

43. A telephone network control point as defined in claim 40, wherein the processor is configured to modify the call information without reference to privacy indicators in the call information.

44. A method of controlling the distribution of call information via a network, comprising:
receiving call information from a service switching point at an intermediate control point; and
altering the call information at the intermediate control point without reference to a privacy restriction indicator.

45. A method as defined in claim 44, wherein altering the call information comprises adding data, changing data or deleting data.

46. A method as defined in claim 44, wherein receiving the call information at the intermediate control point comprises receiving the call information at a signal control point or an adjunct processing system.

47. A method as defined in claim 44, wherein altering the call information comprises altering non-private data associated with the call information.

48. An apparatus for controlling distribution of call information associated with a telephone call, comprising:
a query generator configured to generate a query in response to call information relating to a destination signal switching point;
a switching point identifier configured to identify the destination signal switching point; and
a call information modifier configured to access signal switching point profile information to retrieve profile information associated with the destination signal switching point and to modify the call information based on the profile information associated with the destination signal switching point.
